(19) United States
(12) Patent Application Publication
(10) Pub. No.: US 2015/0239157 A1
(43) Pub. Date: Aug. 27, 2015

(54) Automatic StartUp and Continued Operation of Calendering Drives for Elastomeric Mixes

(71) Applicants: Compagnie generale Des Etablissements Michelin, Clermont-Ferrand (FR); Michelin Recherche et Technique S.A., Granges-Paccot (CH)

(72) Inventors: Almira Aleckovic, Anderson, SC (US); Daniel Robert Rey, Greer, SC (US); Larry Stephen Satterfield, Moore, SC (US)

(73) Assignee: Michelin Recherche et Technique S.A., Granges-paccot (CH)

(21) Appl. No.: 14/418,380

(22) PCT Filed: Jul. 31, 2012
(86) PCT No.: PCT/US12/48918

§ 371 Date: Jan. 29, 2015

(51) Int. Cl. B29C 43/24

(52) U.S. Cl. CPC B29C 43/245; B29K 2021/003

(57) ABSTRACT

The present invention relates to a method that allows the automatic and hands-free threading of a calender set of rolls comprising one or more pairs of rolls that have a nip between them by preventing the skim from sticking to a roll undesirably as it exits the nip. This is particularly useful during startup or when the continuous running of skim through the calender is interrupted or broken. This method also comprises steps that help prevent the interruption of the calendering process including the breaking of the skim being processed. The steps for startup include running the rolls to which the elastomeric mix is desired to stick at slower speeds than other rolls. The steps for maintaining continuous running of the calender after startup include running the rolls to which the elastomeric mix is desired to stick at faster speeds than other rolls.

### FIELD OF THE INVENTION

The present invention relates to a method that allows the automatic and hands-free threading of calender set of rolls comprising one or more pairs of rolls that have a nip between them by preventing the skim from sticking to a roll undesirably as it exits the nip. This is particularly useful during startup or when the continuous running of skim through the calender at higher speeds. This method also comprises steps that help prevent the interruption of the calendering process including the breaking of the skim being processed.

### BACKGROUND OF THE INVENTION

Calenders are mechanisms that include a series of pairs of rolls through which a substance that is malleable can be run in order to smooth out the material and form a skim or sheet of uniform thickness. In the tire industry, calenders are used to process an elastomeric or rubber mix that is usually extruded and then sent through the calender to produce or create a sheet of rubber or elastomer mix. Between each pair of rolls is a gap or nip through which the material is run as the rolls are rotated. Depending on a host of processing variables, the sheet will assume some thickness that is proportional to the width of the nip. Often, the material is fed through three sets of rollers and nips in order to create a homogenous and smooth sheet that also has a desired thickness, as is the case for an inverted “L” configured calender as will be described shortly. This sheet is then used to create some portion of the tire, such as the tread or other semi-finished goods used to manufacture and assemble the tire such as belts and carcass plies, etc.

An illustration of such a typical calendering system 10 is shown in FIGS. 1 and 2, which has three pairs of rolls (labeled as rolls 12, 14, 16, and 18) with a nip between them as well as a fifth roll 20, sometimes referred to as a take-off roller that takes the sheet as it comes off the fourth roll 18. The purpose of this roll is to provide tension to the sheet 22 as it exits the calender and to peel the skim off roller 18. The calender rolls that are part of a pair rotate in opposite directions or in the same linear direction in the nip area 24 so that material that is fed into the entrance 26 of the nip is forced through the nip into the exit area 28 of the nip. For the first pair of rollers, the entrance of the nip is located above the rolls so that material is naturally fed into the nip via gravity upon startup or just before. Usually, a bank 30 of kneaded material (sometimes referred to as a bourelet by the inventor(s)) collects above the nip of the first pair of rolls so that enough material is present to form an uninterrupted sheet of material that can pass through the calendering system. This bank is created by oversupplying slightly the amount of material needed to create the sheet of material from a source of the material such as an extruder. In time, material is forced downward into the nip by the rotation of the rolls.

After exiting the first nip, the material then winds in a counterclockwise direction around the second roll 14 until it is reaches the third roller 16 where it goes through a second nip. Once it exits it winds in a clockwise direction around the third roll 16 and then encounters the fourth roll 18 where it goes through the third nip. At this point, the sheet then attaches to the fourth roll where it is rotates in a counterclockwise direction once more around the bottom and part of the back of the fourth roll and on top of the fifth roll 20 which is rotated in the clockwise direction and which is biased upwards to place the sheet in tension before it proceeds to a production center where some tire component is made using the sheet of material. This desired path is shown by the solid outline of material whereas an unintended circulation of material is represented by the dashed arrows as will be described in further detail later.

All the rolls or pairs of rolls can be commonly driven by a single motor using gears, chains or belts. In such a case, the speed of all the rolls or of the rolls of a pair can be the same or can be different utilizing some sort of transmission system such as a variable speed ratio reducer between the rolls and the motor. Alternatively, all the rolls can be independently driven using a separate motor for each roll. In that case, electronic controls are sometimes furnished that allow tight and independent control of the speed of each roll by way of suitable programming by the operator or sonic other control algorithm executed by a computer. For examples of rolls that are independently driven or that can operate at different adjustable speeds, see U.S. Pat. Nos. 2,333,629; 4,444,361; and G.B. Pat. Nos. 856,454; 620,340.

An example of a production center that can be fed by a calender system is depicted by FIG. 3, which is disclosed in U.S. Patent Application Publication No. 2011036485, which is commonly owned by the assignee of the present invention and whose content is incorporated by reference for all purposes in its entirety. Portions of that application are reproduced herein as follows to describe how the process works and how it can be used in conjunction with the present invention. It should be noted that this is given by way of an example of a production center and that the present invention is equally applicable to any manufacture of a tire component that requires a calendering system of any sort including those that only have a single pair of rolls.

A system 110 for generating a multi-layered tire component in accordance with the methods described in the '485 application is generally shown in FIG. 3. System 110 generally operates to form a multi-layered tire component by winding strips 141 about a building surface. Because tire component is a wound product, it generally forms a complete circle (i.e., a ring). Component is also referred to herein as a band. Also, system 110 generates a sheet 121 from which the strips 141 are formed, and, in particular embodiments, the sheet 121 remains continuous as it travels along a closed-loop path to and from a sheet generator 120. Accordingly, system 110 automatically returns any unused sheet material for reuse by generator 120. System 110 generally forms elastomeric tire components, such as, for example, tread, sub-tread, and cushion gum. It can also create a multi-layered band that is a profiled tire tread band.

In this embodiment, system 110 comprises a sheet generator 120, a cutting assembly 140, a strip applicator assembly 160, a recovery assembly 170, and a programmable logic controller (not shown). System 110 may also include a roller assembly 130 for directing a sheet 121 from generator 120 to cutting assembly 140. Sheet generator 120 generally transforms input material 112 into a sheet 121, which is ultimately cut into strips 141 by cutting assembly 140. With continued reference to FIG. 3, input material 112 is received through inlet 122, and may comprise new material 112a and/or previously used material 112b supplied by recovery assembly 170. After receiving input material 112, generator 120 forms the input material by any known means such as by a calendering system shown in FIGS. 1 and 2 and described above into sheet 121, where sheet 121 is formed to any desired width and thickness. Sheet 121 is expelled from generator 120 by way of outlet 124.

In one embodiment, as shown in FIG. 3, generator 120 comprises an extruder. Extruders generally push input material 112 through a die or head, such as by way of a screw. Any extruder known to one of ordinary skill in the art may be used by system 110. Generator 120 may also comprise a calender, in lieu of or in addition to an extruder, which may comprise a pair of rollers positioned in close proximity to each other to form a gap or nip, through which input material 112 passes to from a sheet 121 (as described above). The resulting sheet 121 includes a width associated with the width of the calender nip.

As shown in FIG. 3, a roller assembly 130 may be located between sheet generator 120 and cutting assembly 140. Roller assembly 130 generally comprises one or more rolls 132 arranged to form a translation path of sheet 121. The take up roller described above in FIGS. 1 and 2 may be considered as such a roll. The particular translation path directs sheet 121 to cutting assembly 140, and may be used to tense sheet 121 as desired. The location of rolls 132 may be adjusted to impart more or less tension on sheet 121, which may also provide a means for adjusting the cross-sectional dimensions of sheet 121. One or more rolls 132 may be driven or powered, such as, for example, by a motor, to assist in the translation of sheet 121, and/or adjustment of tension in sheet 121. In addition, biasing means such as springs, pneumatic or hydraulic cylinders, etc. may force the roll against the sheet to provide tension. Sheet 121 may also be tensed by creating a speed differential between drum 125 and/or cutting drum 152, by increasing or decreasing the rotational speed of either drum.

Cutting assembly 140 generally forms strips 141 from sheet 121 for subsequent assembly of the tire band. More specifically, cutting assembly 140 utilizes a plurality of cutting members 142 to cut strips 141, wherein each cutting member 142 includes a cutting edge 143. Cutting members 142 generally are spaced along a length of sheet 421, and along a circumference of cutting surface and/or cutting drum 152. In the embodiment shown in the FIGURES, cutting members 142 are rotating knives. Rotating knives, in the embodiment shown, operate similarly to idler wheels, and freely rotate at the direction of the translating sheet 121. Still, rotating knives 142 may be driven by a motor or any other known driving means. Also, other means for cutting sheet 121 known to one of ordinary skill in the art may be used in lieu of rotating knives, including other non-rotating knives, blades, or edges.

With general reference to FIG. 3, system 110 also includes an applicator assembly 160 for applying one or more continuous strips 141 to a building surface to form a band. The one or more strips 141 are wound about the building surface to form the multi-layered band. Applicator assembly 160 includes an applicator drum 162 that transfers one or more strips 141 there from to building assembly 180. To provide adhesion between applicator drum 162 and strips 141, which promotes the separation of strips 141 from sheet 121, applicator drum 162 may be heated or cooled. In particular embodiments, applicator drum 162 is maintained at a temperature at least 10 degrees Celsius higher than the temperature of sheet 121 and/or any strips 141. In other embodiments, applicator drum 162 is maintained at approximately 70 degrees Celsius. The surface of applicator drum 162 may comprise a smooth surface, which may be a chromed or hot chromed surface, so to provide a smooth, capillary-like surface that may promote molecular bonding and/or may operate like a vacuum to facilitate retention of strips 141 thereon. Improved adhesion may also be provided by providing a rough surface, the rough surface providing increased surface area for improved contact area, and therefore, increased adhesion. Applicator drum 162 may also operate as the cutting drum 152. Further, the temperature controls and conditions, as well as the surface conditions and treatments discussed with regard to applicator drum 162 above may also be applied to cutting drum 152 to improve adhesion between drum 152 and sheet 121. Using this system, tread features can be built onto a green or uncured tire layer by layer.

As just described regarding the applicator or cutting drum, the adhesion of rubber strips to a round and rotating surface is apt to occur. Accordingly, when multiple rotating surfaces are present near the exit of the nip of calender rolls, e.g. their respect circumferential surfaces that are rotating away from nip exit, a sheet of elastomeric mix can bond with either of these surfaces, or partially to both at the same time. This can be a problem during the operation of the calender, but especially during the initialization or start-up of the calender as an initial sheet needs to be directed, often by an operator, to follow the proper path until the calender has been successfully “threaded” and is ready to supply a sheet of material to the desired production center. This requires shut-clown of the equipment for safety reasons, which can be costly.

Looking back at FIG. 2, the desired path is denoted by the solid outline of material and the unwanted paths by dashed arrows. As can be seen, the first unwanted path can occur when the sheet sticks to the first roll 12 where it rotates clockwise away from the exit 28a of the first nip 24a. This can lead it back to the top bank 30a of kneaded material, creating an undesirable feedback loop where excessive material will spill of the axial ends of the roll and down the sides of the calendering apparatus, potentially causing damage to the apparatus or other equipment by gumming up the equipment. It also interrupts the production of the skim, stopping the production process when supplying it in real time. A similar situation can occur when the sheet exits the second nip 24b as it can continue to run clockwise on the second roll 14 and into the top bank of material 30a. After the third nip 24c, the material can recycle itself back to the second nip 24b, creating unwanted growth of a second bank 30b of material. Finally, after the sheet comes back around the bottom of the fourth roll 18, it can continue to stick to this roll and create a third bank 30c of material near the entrance 26c of the third nip 24c.

Any of these banks of material can become too large and cause the equipment problems. Even after initially threading the calender, all three banks can occur due to sonic small residue sticking to the rolls and collecting near the entrance to the nips over time, thereby causing some small amount of recycling. Also, there is a desired amount of slight oversupply to the first nip to ensure enough material is present for the step reduction in skim thickness at each nip which creates a full width sheet that is smooth, homogenous and that has the correct thickness. So, it is desirable to control the size of the banks of material but not to eliminate them altogether.

The reason elastomeric mixes are tacky will now be explained. Suitable compositions for making a sheet for use in tire components such as treads include those rubber compositions having a glass transition temperature within a defined range, said rubber compositions being based upon a diene elastomer, a plasticizing system and a cross-linking system. The diene elastomers or rubbers that are useful for such rubber compositions are understood to be those elastomers resulting at least in part, i.e., a homopolymer or a copolymer, from diene monomers, i.e., monomers having two double carbon-carbon bonds, whether conjugated or not.

In summary, tyical diene elastomers include highly unsaturated diene elastomers such as polybutadienes (BR), polyisoprenes (IR), natural rubber (NR), butadiene copolymers, isoprene copolymers and mixtures of these elastomers. Such copolymers include butadiene/styrene copolymers (SBR), isoprene/butadiene copolymers (BIR), isoprene/styrene copolymers (SIR) and isoprene/butadiene/styrene copolymers (SBIR). Suitable elastomers may also include any of these elastomers being functionalized elastomers.

In addition, the elastomeric composition disclosed herein may further include a reinforcing filler. Reinforcing fillers are added to, inter alia, improve the tensile strength and wear resistance of the material. Any suitable reinforcing filler may be suitable for use in compositions disclosed herein including, for example, carbon blacks and/or inorganic reinforcing fillers such as silica, with which a coupling agent is typically associated. Inorganic reinforcing fillers may take many useful forms including, for example, as powder, microbeads, granules, balls and/or any other suitable form as well as mixtures thereof. Examples of suitable inorganic reinforcing fillers include mineral fillers of the siliceous type, such as silica (SiO2), of the aluminous type, such as alumina (ALO3) or combinations thereof.

For coupling the inorganic reinforcing filler to the diene elastomer, coupling agent that is at least bifunctional provides a sufficient chemical and/or physical connection between the inorganic reinforcement filler and the diene elastomer. Examples of such coupling agents include bifunctional organosilanes or polyorganosiloxanes. Such coupling agents and their use are well known in the art. The coupling agent may optionally be grafted beforehand onto the diene elastomer or onto the inorganic reinforcing filler as is known. Otherwise it may be mixed into the rubber composition in its free or non-grafted state.

In addition to the diene elastomer and reinforcing filler, particular embodiments of the rubber composition disclosed herein may further include a plasticizing system. The plasticizing system may provide both an improvement to the processability of the rubber mix and/or a means for adjusting the rubber composition's glass transition temperature and/or rigidity. Suitable plasticizing systems may include a processing oil, plasticizing resin or combinations thereof. Other plasticizing systems are known.

Also, the rubber compositions disclosed herein may have and be cured with any suitable curing system including a peroxide curing system or a sulfur curing system, many of which are known in the art. Other additives can be added to the rubber compositions disclosed herein as known in the art. Such additives may include, for example, some or all of the following: antidegradants, antioxidants, fatty acids, pigments, waxes, stearic acid and zinc oxide.

These constituents, notably the polymers used in the elastomeric mix, make the sheet sticky or have tack. Increasing the amount or type of certain ingredients such as pigments, fillers, additives, and plasticizers can increase tack. Also, sonic polymers have inherently more tack than others. Consequently, different mixes have more tack than others and can therefore be more prone to the problems just described.

As can be imagined, a number of methods have been devised to control unwanted sticking of the sheet of material to calender rolls. Some methods have been already described above and include providing a temperature or surface finish differential between the two rolls that define a nip so that the sheet of material is prone to stick to one versus the other. Also, surface treatments that decrease adhesion to the roll to which adherence is undesirable after the sheet exits the nip can be applied to that roll. Such treatments include TEFLON, alkanolamines, alkylene glycols, and polyalkylene glycols (see U.S. Pat. No. 3,841,899). In Japanese Patent Application Publication No. JP9201838A, there is disclosed a method of continually applying a release agent on a roll using a soft roll onto which the agent is sprayed that rubs against the roll for solving sticking problems associated with that roll. Finally, the use of scraper blades is often used to prevent the unwanted recycling of material that can contribute to bank growth over time (See Jap. Pat. Application Publication No. 08-197558 A and U.S. Pat. No. 4,221,022 for examples). Also, the use of scraper blades to prevent the improper threading of a sheet processed by a calender processing elastomeric mixes, preventing it from recycling to the entrance of the nip thereby aiding in the start-up of a calendering process is also known (see col. 3, lines 5-10 of U.S. Pat. No. 4,871,409).

However, all these methods have drawbacks. Concerning maintaining the temperature of the rolls, it is necessary to maintain consistency the entire time the calendering apparatus is running, which could be difficult depending on ambient conditions or can be beyond the temperatures permitted by the mix. Also, this method could delay start-up until the rolls reach the desired temperature. Surface treatments that are applied to rolls such as disclosed in U.S. Pat. No. 3,841,800 can wear off over time which adds cost to reapply the treatment and possibly some downtime for the equipment as well as unwanted contamination for the mix. Continuously applying a release agent can be both expensive, messy and may cause the agent to seep into the material causing a degradation of the properties of the sheet of material. Finally, scraper blades do not allow for the automatic, hands-free threading of a calender processing an elastomeric mix as admitted by the prior art (see comments regarding U.S. Pat. No. 4,871,409 above).

Accordingly, a method for solving the sticking issue upon startup in a more reliable and cost-effective way without degrading the material properties of the sheet produced by the calender is warranted. More particularly, such a method that does not require significant increase in capital expenditure would be helpful. Such a method that allows the automatic and hands-free threading of the apparatus would be particularly beneficial. It would be also desirable if the proposed solution worked on the stickiest of elastomeric mixes. Furthermore, a method that helped maintain uninterrupted continuous production of the calendering system after startup would also be useful.

### SUMMARY OF THE INVENTION

Aspects and advantages of the invention will be set forth in part in the following description, or may be obvious from the description, or may be learned through practice of the invention.

The present invention includes a method for operating a calendering system that processes elastomeric mixes at a desired calendering rate. The calender comprises a pair of rolls having a nip between said rolls. The method includes the following steps:

initializing or starting up the calendering system, said initializing step comprising the following steps:

determining which roll it is desirable for the elastomeric mix to follow; and

reducing the speed of said roll to which is desirable for the elastomeric mix to follow as compared to the other roll thereby creating a speed differential.

In many cases, this initialization step is accomplished in a hands-free manner, meaning no physical or manual manipulation of the elastomeric mix is necessary or needed to thread the calender.

The method may further comprise the following step:

running continuous production after the calender system has been initialized, said running continuous production step comprising the following step: reversing the speed differential between a pair of rolls having a nip between them so that the roll to which it is desirable for the elastomeric mix to follow is running at a faster speed than the other roll.

In some embodiments, the speed differential can be as much as 5 to 10% when initializing. The speed differential can then be reversed to run production, in which case, the differential can then be as high as 25%.

The present invention has been successful in processing very tacky mixes including those that have limonene content or that have over 15% PHR total plasticizer content (including resin and oil). It is contemplated that it can work on other mixes as well. Also, the present invention may be applied to a calender system comprising a plurality of rolls.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of standard calendering apparatus.

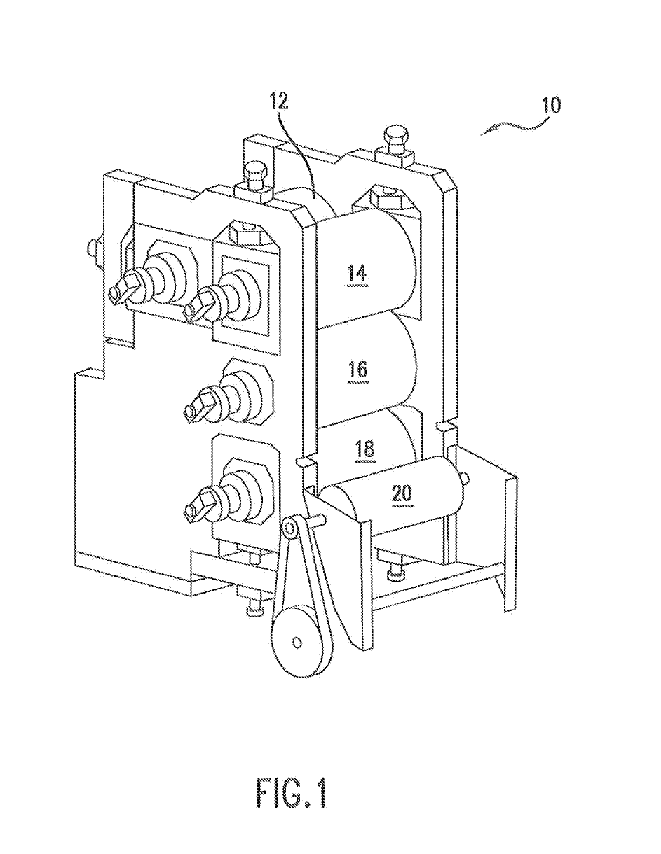

FIG. 2 is a side view of the rolls of the calendering apparatus shown in FIG. being removed from the apparatus for enhanced clarity.

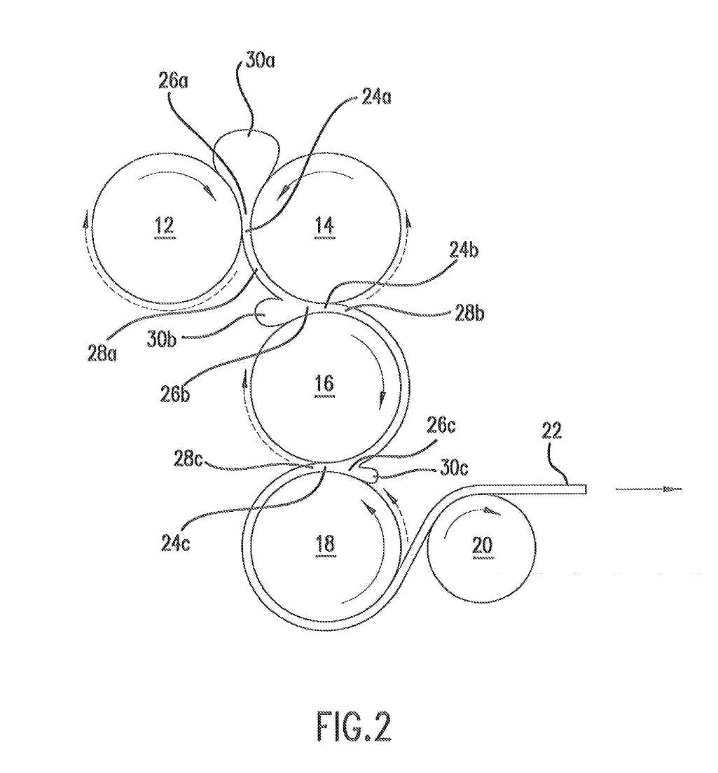

FIG. 3 shows a production center that uses calendered sheet for making strips that are applied to a green the to create the tread of a tire.

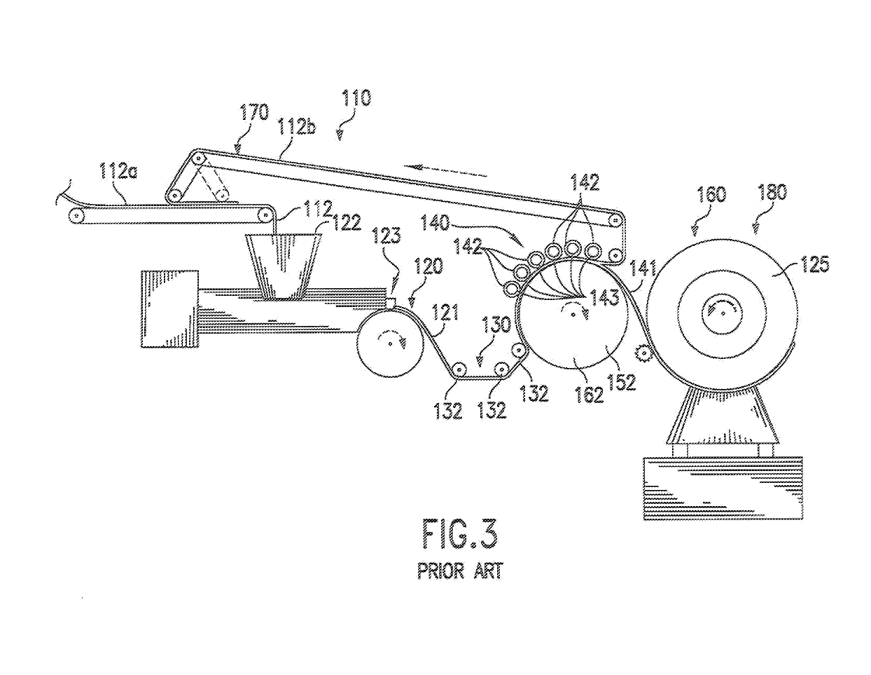

The use of identical or similar reference numerals in different figures denotes identical or similar features.

### DETAILED DESCRIPTION OF THE INVENTION

For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

As used herein, “elastomeric mix” refers to a variety of possible compositions—natural and synthetic—as may be used to construct various portions of a tire. A more complete description of these variants is found above in the

### BACKGROUND OF THE INVENTION,

As used herein, “roller speed” refers to the linear speed of a roller at its circumference and not its angular rotation or RPM. It is to be understood that the controllers for most calendering systems can translate linear speed to RPM easily so that a user typically inputs the desired linear speed of a roll. When referring to these speeds in percentages, it is to be understood that they represent percentages of the desired linear production rate of the skim produced by the calendering system. Typical calendering rates range from 5 to 100 meters per minute and were used when testing out the present invention.

Upon initialization or startup, the inventors found it beneficial for the processing of some mixes to slow down the roll to which it was desired for the skim to stick as compared to the other roll with which it forms a nip. For example, it may be beneficial to slow down second roll 14 as compared to first roll 12 by as much as 5 to 10 percent. Likewise, it might be beneficial to slow down third roll 16 by 5 to 10 percent as compared to second roll 14. Finally, hands-free threading may be accomplished by slowing down fourth roll 18 by 5 to 10 percent as compared to the third roll 16. In other words, the ratios of the speeds of the rolls upon startup before an elastomeric mix is sent through the first nip 24a, would be as follows: R14=90 to 95% of R12; R16=90 to 95% of R14; R18=90 to 95% of R16. in such a case, the skim will thread itself appropriately without following the wrong roll after it exits any of the nips. The inventors have tested this on the stickiest mix (later referred to as mix 1) they have encountered, which has 8.7% PHR of a polymerized oil obtained from citrus fruits (Limonene) and that is also heavily loaded with other plasticizers and found that it allows the mix to be threaded hands-free. The skim can then supply a production center as previously described.

After startup, the inventors have found it useful to reverse these roll speed differentials to help maintain the proper routing of the skim. This was tested on four different mixes using different speed differentials and it was found that it decreased the probability of misrouting, unwanted sticking and skim breakage, all of which may result in downtime of the calendering apparatus and production center in order to clean up and thread the system once again. Table 1 gives this information in tabular format below. Note that it is the overall total plasticizer content and type of resin that contribute most to the tack of the elastomeric mixes and these mixes were chosen as being quite tacky.

TABLE 1

| | | Total | | | | | |
|---|---|---|---|---|---|---|---|
| | | Plasticizer | R12 | R14 | R16 | R18 | R20 |
| | | PHR | (roll | (roll | (roll | (roll | (roll |
| Mix | Resin | (includes oil | speed as | speed as | speed | speed | speed |
| # | PHR | and resin) | %) | %) | as %) | as %) | as %) |
| 1 | 8.8%¹ | 21.8% | 61 | 72 | 85 | 100 | 150 |
| 2 | 14.4%² | 16.7% | 95 | 100 | 105 | 110 | 115 |
| 3 | 14.5%² | 16.9% | 95 | 100 | 105 | 110 | 115 |
| 4 | 4.4%¹ | 19.2% | 50 | 60 | 80 | 100 | 130 |

¹Limonene resin
²Aliphatic Hydrocarbon resin

As can be seen, a speed differential ranging from 5 to 20% was used between the pairs of rolls of the calendering apparatus to maintain continuous production for these mixes. In other words, a roll that was running slower than an associated roller of a pair of rollers is now moving faster than the other roll. However, the inventors have encountered situations where as much as a 25% overdrive was used to prevent the skim from following the wrong roll during production.

The inventors have theorized why reversing the speed differentials from startup to production works. Upon startup, there is no tension on the skim so its tendency to stick is a matter of the bonding force of the skim in the nip area to one roll versus the other. By slowing down a roll, the bond forces are subjected to less shear force as compared to the roll rotating more quickly, causing the skim to stick to the slower moving roll. Once production is commenced after threading, the skim is under tension so it is effective to increase the speed of the roll to which the skim is adhered as this increases the tension in the skim, helping to overcome the bond forces between the skim and the roll to which it is undesirable for the skim to stick. Of course, it is contemplated that this might not work for all situations and for all types of elastomeric mixes.

Typical skim thicknesses for which the present invention has been successfully tested ranges from 1 to 1.6 mm on average but it is contemplated that this might work for other skim thicknesses as well. For example, thicknesses as high as 1.8 mm and as low as .9 mm were successfully tested. Also, the roll diameters for the first through fourth rolls was 250 mm and the roll diameter for the fifth roll was 150 mm but it is contemplated that this invention will work with other roll diameters as it is the differential in relative linear speeds of the surfaces of the rolls that creates the desirable forces that direct the proper routing of the skim at various times including startup and production. Testing has revealed that this invention works at typical calendering rates but it is contemplated that it will work on other rates as well.

Furthermore, the present invention has been accomplished without requiring adding equipment, which keeps the cost of the equipment desirably low. However, it is contemplated that the present invention could be implemented by using any of the methods already known and that will be devised in the art to help manage unwanted sticking in calendering systems, including those that add additional equipment. Furthermore, in many instances the present invention can eliminate the need for human intervention when threading the calender but occasionally some intervention may be necessary so the present invention is not necessarily limited to completely “hands free” initialization.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for operating a calendering system that processes elastomeric mixes at a desired calendering rate comprising a pair of rolls having a nip between said rolls, said rolls capable of rotating at various speeds, said method comprising the following steps:
initializing or starting up the calendering system, said initializing step comprising the following steps:
determining which roll it is desirable for the elastomeric mix to follow; and
reducing the speed of said roll to which is desirable for the elastomeric mix to follow as compared to the other roll thereby creating a speed differential.

2. The method of claim 1 which further comprises the step of providing a plurality of pairs of rolls with nips between each roll of a pair wherein said determining step and said speed reduction step are applied to each of said pairs of rolls.

3. The method of claim 1 wherein said speed reduction step comprises reducing the speed of said roll to which it is desirable for the elastomeric mix to follow by at least 5% as compared to the other roll.

4. The method of claim 3 wherein said speed reduction step comprises reducing the speed of said roll to which it is desirable for the elastomeric mix to follow by as much as 10% as compared to the other roll.

5. The method of claim 1 which further comprises the following step:
running continuous production after the calender system has been initialized, said running continuous production step comprising the following step:
reversing the speed differential between a pair of rolls having a nip between them so that the roll to which it is desirable for the elastomeric mix to follow is running at a faster speed than the other roll.

6. The method of claim 5 which further comprises the step of providing a plurality of pairs of rolls with nips between each roll of a pair wherein said determining step and said speed reduction step are applied to each of said pairs of rolls and wherein said speed reversal step is applied to each of said pairs of rolls after the calender has been initialized.

7. The method of claim 6 wherein said speed reversal step includes running one roll at least 5% faster than the other roll.

8. The method of claim 7 wherein said speed reversal step includes running one roll at least 20% faster than the other roll.

9. The method of claim 8 wherein said speed reversal step includes running one roll at least 25% faster than the other roll.

10. The method of claim 1 wherein said calendering system produces a skim having a thickness that ranges from 1 to 1.6 mm.

11. The method claim I wherein said calendering rate ranges from 5 to 100 meters per minute.

12. The method of claim I wherein said rolls have a diameter that ranges from 150 to 250 mm.

13. The method of claim 1 wherein the elastomeric mix being processed has limonene content.

14. The method of claim 1 wherein the elastomeric mix being processed has at least 15% PHR total plasticizer content.

15. The method of claim 1 wherein said initializing step is accomplished without needing to physically manipulate the elastomeric mix manually.
